(19) United States
(12) Patent Application Publication
(10) Pub. No.: US 2025/0249613 A1
(43) Pub. Date: Aug. 7, 2025

(54) RAZOR CARTRIDGES

(71) Applicant: SL Shaveco LLC, Beverly, MA (US)

(72) Inventors: Ralph K. MAIDER, JR., Milton, MA (US); Andre CHMYROV, Taunton, MA (US)

(21) Appl. No.: 18/433,760

(22) Filed: Feb. 6, 2024

(51) Int. Cl. B26B 21/22; B26B 21/40

(52) U.S. Cl. CPC B26B 21/222; B26B 21/4018

(57) ABSTRACT

Razor cartridges are disclosed that include (a) an elongated housing comprising a generally rectangular main portion defining a central open area and having a first width, and a shelf portion extending from the main portion and terminating in a leading edge, the shelf portion having a second width narrower than the first width, (b) a plurality of blades disposed within the open area of the main portion of the housing, and (c) a pair of clips disposed on opposite sides of the open area and configured to secure the blades in the housing, each clip having a pair of legs that wrap around the main portion of the housing outboard of the open area and are bent against a lower surface of the main portion. Shaving systems and methods of shaving are also disclosed.

### BACKGROUND

Shaving systems often consist of a handle and a cartridge in which one or more blades are mounted in a plastic housing. In some cases, the blades are held in place in the housing by a pair of clips, mounted at opposite ends of the length of the blades. In addition to holding the blades in place, the clips can also define the blade exposure. In some cases, the clips are fabricated from aluminum or any other sacrificial electrochemical element or alloy that will prevent the blades from corroding.

Each of the clips may be wrapped around the outer surface of the housing or secured in place by being inserted through holes in the housing in the manner of a staple. In both cases, the legs of the clips that extend below the housing are bent around the housing, again in a staple-like shape. Inspection of the clips is an important step in manufacturing, to ensure that the clips have been properly assembled onto the cartridge.

### SUMMARY

In general, the present disclosure pertains to razor cartridges (also known as blade units), and to shaving systems and replaceable shaving assemblies that include such cartridges.

In one aspect, the disclosure features a razor cartridge comprising (a) an elongated housing comprising a generally rectangular main portion defining a central open area and having a first width, and a shelf portion extending from the main portion and terminating in a leading edge, the shelf portion having a second width narrower than the first width, (b) a plurality of blades disposed within the open area of the main portion of the housing, and (c) a pair of clips disposed on opposite sides of the open area and configured to secure the blades in the housing, each clip having a pair of legs that wrap around the main portion of the housing outboard of the open area and are bent against a lower surface of the main portion.

Some implementations include one or more of the following features. The razor cartridge may further include an elastomeric guard mounted on the shelf portion such that at least a portion of the elastomeric guard extends beyond the main portion of the housing. The elastomeric guard may comprise a plurality of longitudinally extending fins extending upward from a common base. At least some of the fins may be disposed outside of the main portion of the housing. The shelf portion may extend beyond the main portion a distance of about 2 to 4 mm. The fins may have different lengths, in which case a longest fin may be positioned adjacent the leading edge of the shelf. Both of the legs of each clip may be visible along their entire length. The second width (the width of the shelf) may be about 5 to 10 mm less than the first width (the width of the main portion).

In another aspect, the disclosure features a shaving system comprising: a handle, and a razor cartridge mounted on a distal end of the handle. The razor cartridge (a) an elongated housing comprising a generally rectangular main portion defining a central open area and having a first width, and a shelf portion extending from the main portion and terminating in a leading edge, the shelf portion having a second width narrower than the first width, (b) a plurality of blades disposed within the open area of the main portion of the housing, and (c) a pair of clips disposed on opposite sides of the open area and configured to secure the blades in the housing, each clip having a pair of legs that wrap around the main portion of the housing outboard of the open area and are bent against a lower surface of the main portion.

Some implementations of this aspect may include any one or more of the features discussed above.

In a further aspect, the invention includes a method of shaving, the method comprising contacting the skin with a razor cartridge comprising (a) an elongated housing comprising a generally rectangular main portion defining a central open area and having a first width, and a shelf portion extending from the main portion and terminating in a leading edge, the shelf portion having a second width narrower than the first width, (b) a plurality of blades disposed within the open area of the main portion of the housing, and (c) a pair of clips disposed on opposite sides of the open area and configured to secure the blades in the housing, each clip having a pair of legs that wrap around the main portion of the housing outboard of the open area and are bent against a lower surface of the main portion.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a razor cartridge according to one implementation.

FIG. 2 is a top view of the razor cartridge shown in FIG. 1.

FIG. 3 is a side view of the cartridge.

FIG. 3A is a cross-sectional view of the cartridge taken along line A-A in FIG. 1, with the clip shown in broken lines for reference regarding its location relative to other components.

FIG. 4 is a bottom view of the cartridge.

FIG. 5 is a front view of the cartridge.

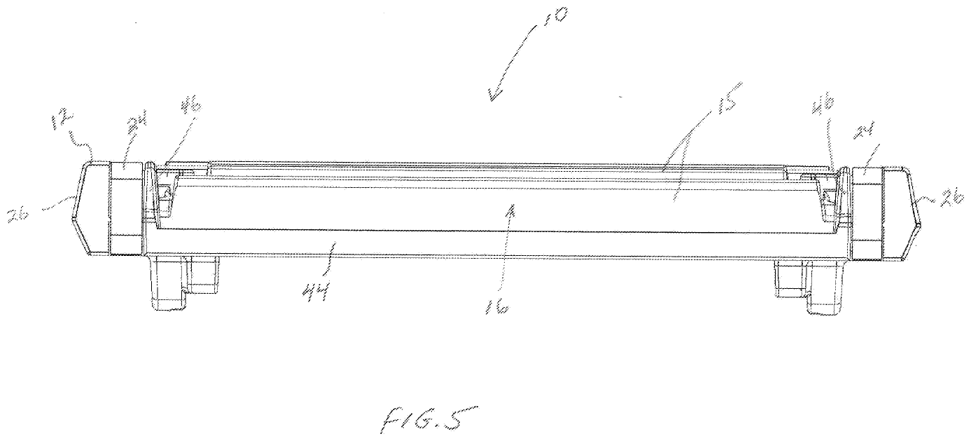

FIG. 6 is a perspective view of the housing of the cartridge shown in FIG. 1.

FIG. 7 is a top view of the housing.

FIG. 8 is a bottom view of the housing.

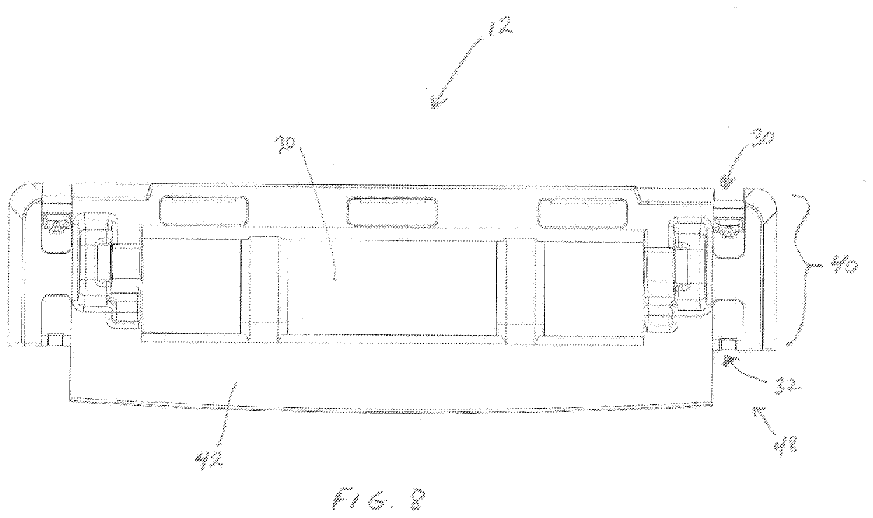

FIG. 9 is a front view of the housing.

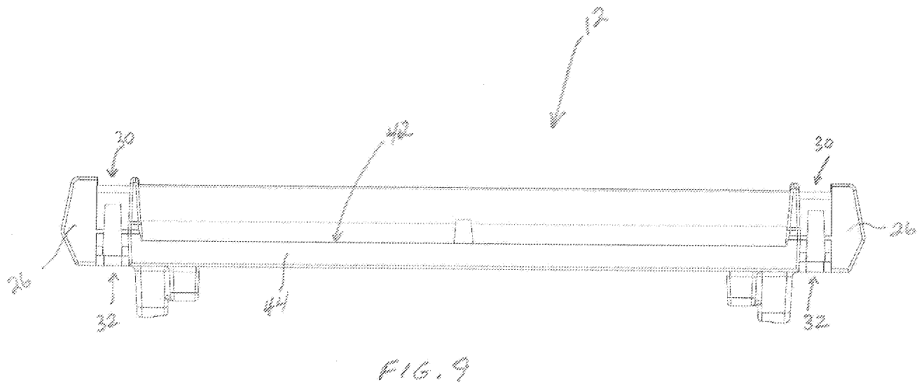

FIG. 10 is a front view of an alternative embodiment in which the side walls of the shelf portion of the housing are omitted.

FIG. 11 is a perspective view of an alternative embodiment in which the guard wraps around the sides of the shelf portion.

FIG. 11A is a bottom view of the cartridge shown in FIG. 11.

### DETAILED DESCRIPTION

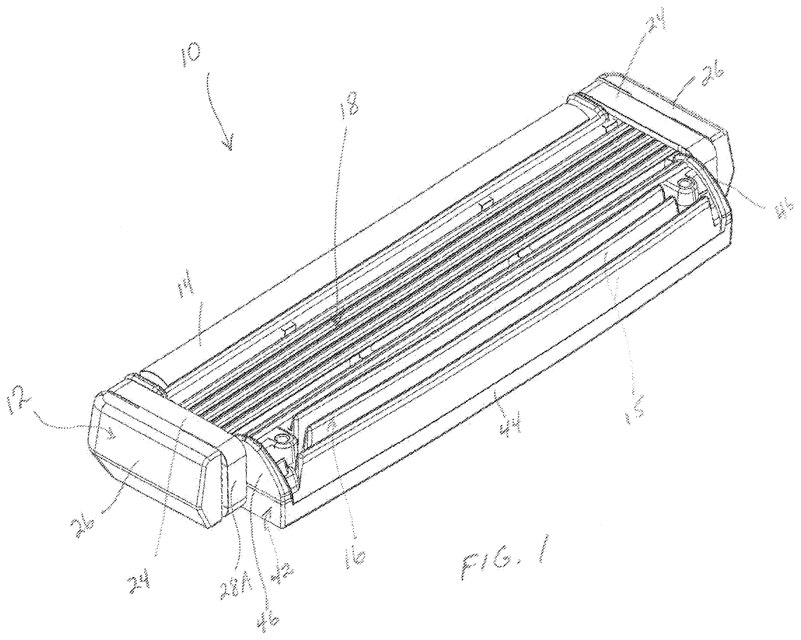

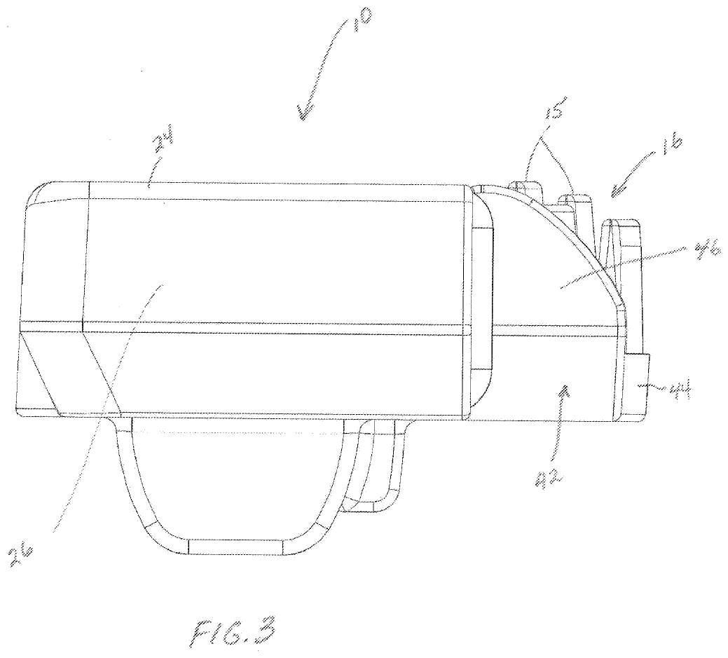

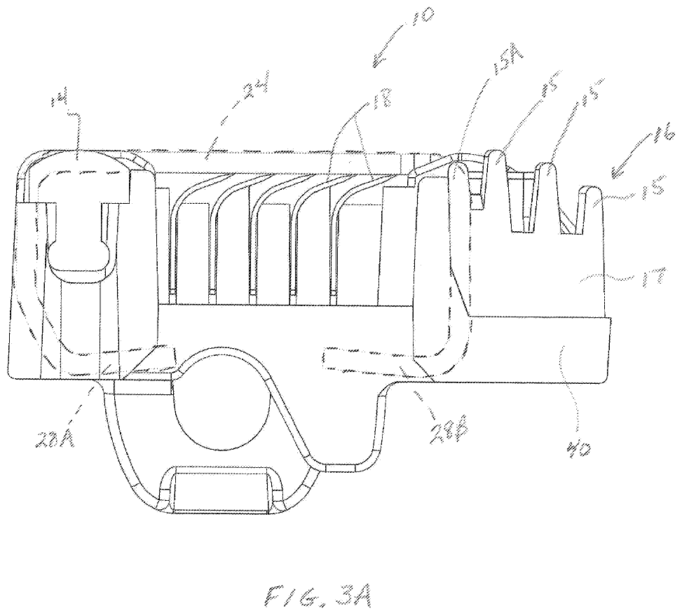

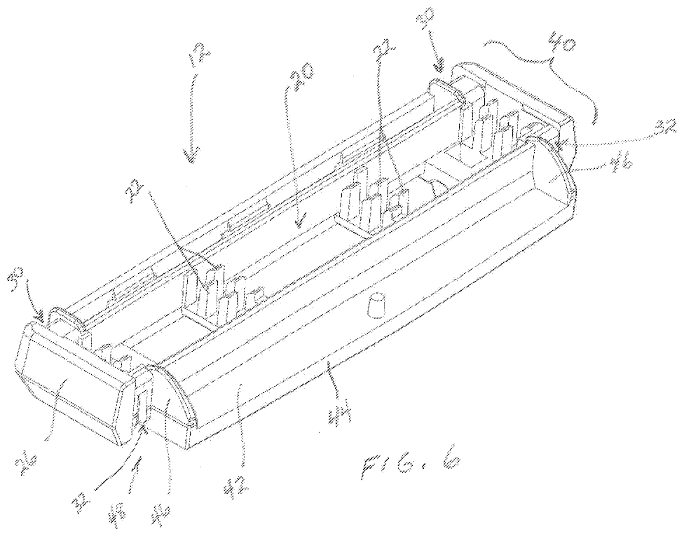

FIG. 1 shows a razor cartridge 10 that includes a housing 12, a cap 14, a guard 16, and a plurality of blades 18 disposed between the cap 14 and guard 16. As shown in FIG. 3A, the guard 16 includes a plurality of elastomeric fins 15 extending upwardly from a common base 17, as described in U.S. Pat. No. 10,967,531, the full disclosure of which is incorporated by reference herein. Blades 18 are disposed in a central open area 20 of the housing 12, shown in FIG. 6, and are positioned by alternating blade positioning elements 22 (FIG. 6).

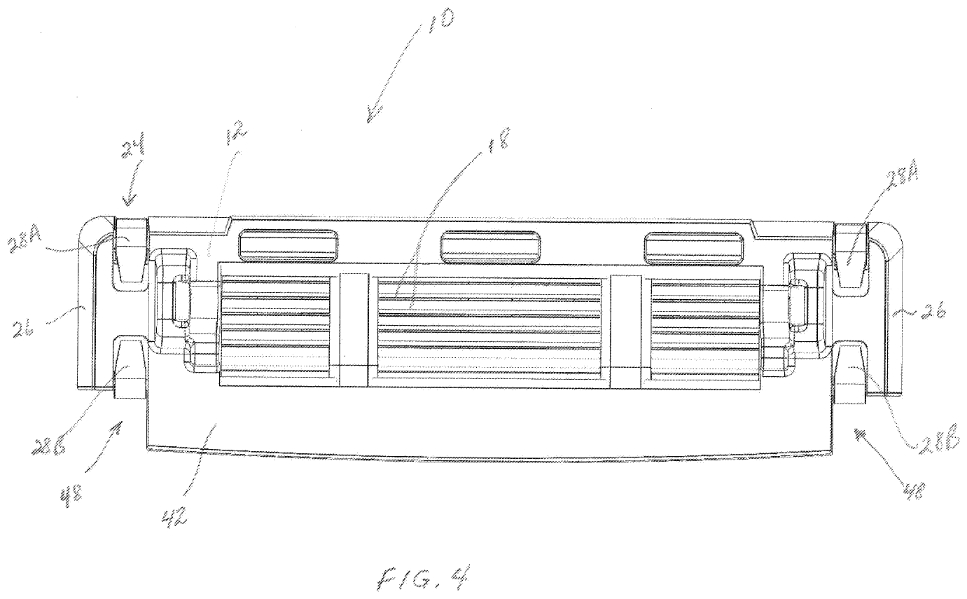

A pair of clips 24, disposed just inboard of the short ends 26 of the housing 12, maintain the blades in the desired blade geometry and retain the blades securely in the housing. As shown in FIG. 4, each clip has a pair of legs 28a, 28b. A first leg 28a of each clip is received in a first channel 30 and a second leg 28b of each clip is received in a second channel 32 (FIG. 6) allowing both legs to be easily wrapped around the housing and secured at the bottom of the housing in staple fashion during manufacturing, resulting in the arrangement shown in FIG. 4. This manner of assembly allows flexibility in clip design and manufacturing equipment. Because the full length of each clip can be seen, the clips can be easily inspected during assembly.

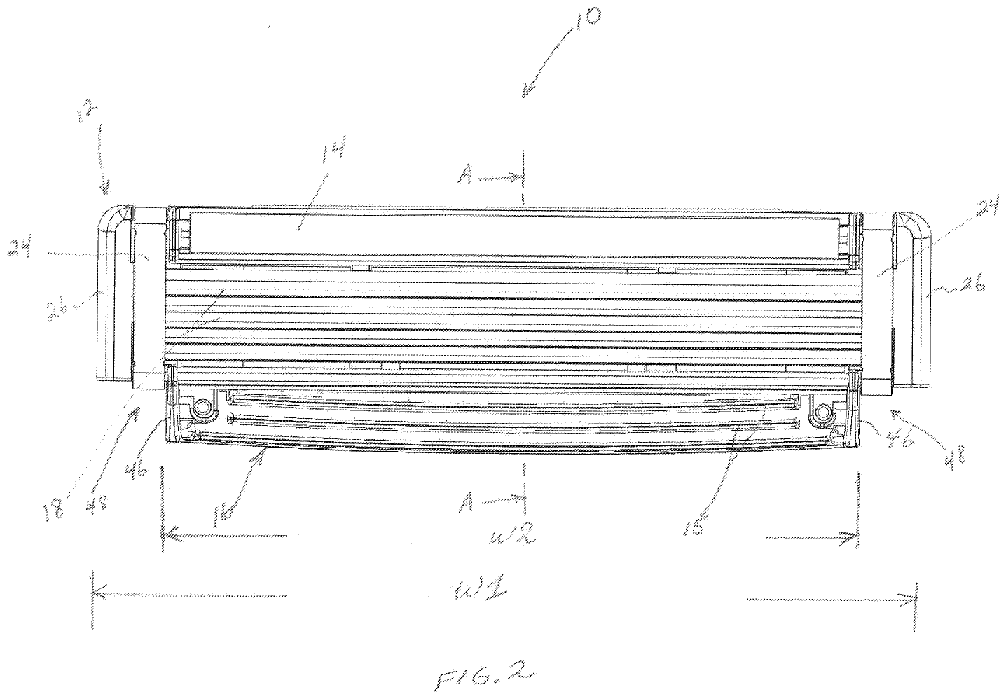

Referring to FIGS. 2, 6 and 7, the housing 12 includes a generally rectangular main portion 40 having a width W1 and a narrower shelf portion 42 having a width W2. The shelf portion extends centrally from the main portion and its width is substantially equal to the distance between the inner edges of the clips 24.

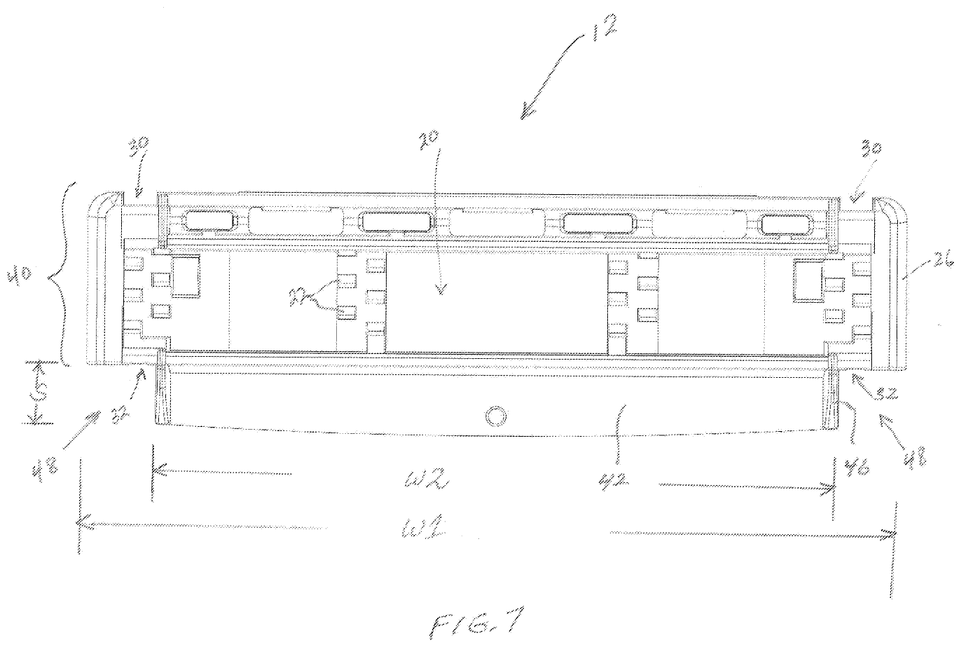

The front edge 44 of the shelf portion 42 defines the leading edge of the razor, i.e., the first area of contact of skin with the razor. The fins 15 of the guard have different lengths, as can be seen, e.g., in FIG. 2, and the longest of the fins is positioned adjacent the leading edge of the cartridge, as defined by front edge 44. Measured at a side edge of the shelf portion 42, as shown in FIG. 7, the shelf portion extends a distance S of about 2 to 4 mm from the main portion 40, in some cases about 2.5 to 3.5 mm.

The guard 16 is mounted on the shelf portion 42 as shown in FIGS. 1 and 2. The shelf portion 42 is provided with side walls 46 to locate the guard during manufacturing and support the guard during use. The side walls 46 have a curved profile.

The width of the guard 16 is substantially equal to that of the shelf portion 42, such that only the side walls 46 extend beyond the sides of the guard. In some implementations the side walls 46 have a wall thickness of less than 5 mm so that the plastic of the shelf does not extend significantly beyond the guard on each side.

This arrangement provides open areas 48 (FIG. 2) on either side of the guard, making it easier for a user to manipulate and maneuver the razor cartridge in narrow, difficult to shave areas. Leaving these areas 48 open may also enhance the contact obtained between the guard 16 and the user's skin by removing potential areas of non-functional contact between the housing and the skin on either side of the guard.

As can be seen in FIGS. 1, 2, and 3A, the main portion 40 of housing 12 is configured such that the vertical portion of each second leg 28b is aligned with the last elastomeric fin 15A that contacts a user's skin prior to the skin contacting the first blade 18a (FIG. 3A). This arrangement of the clips 24 significantly rearward of the leading edge of the cartridge (defined by the edge 44 of shelf 42) provides the open area 48 discussed above and increases the likelihood that the first point of contact between the user's skin and the cartridge will be the leading elastomeric fin of the guard 16.

### OTHER EMBODIMENTS

A number of embodiments have been described. Nevertheless, it will be understood that various modifications may be made without departing from the spirit and scope of the disclosure.

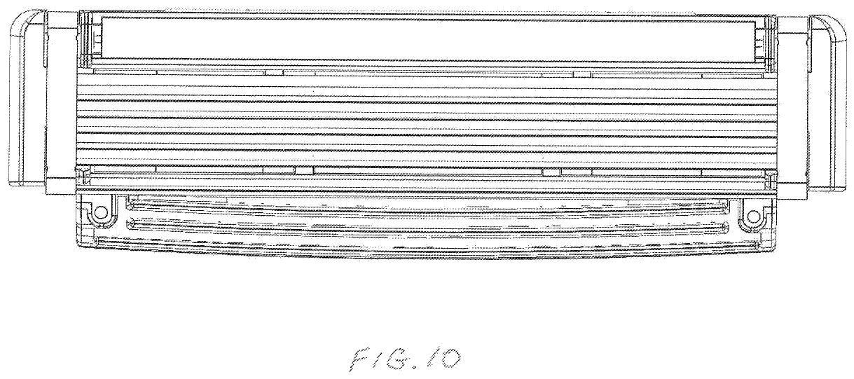

For example, in some implementations the side walls of the shelf portion of the housing may be omitted such that the guard extends the full width of the shelf portion, as shown in FIG. 10.

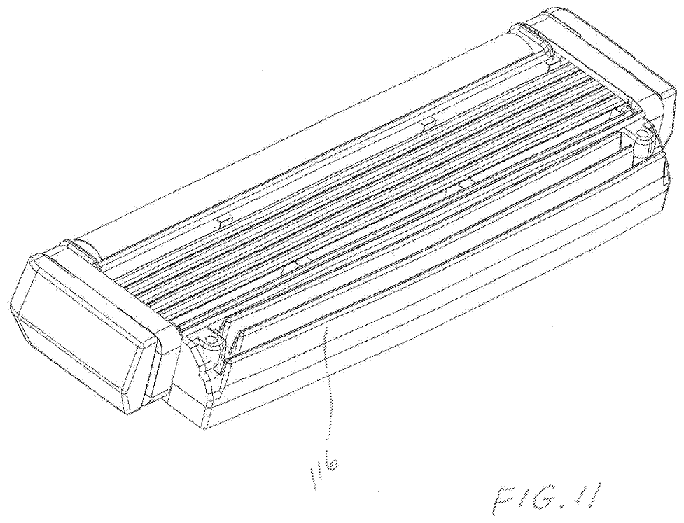

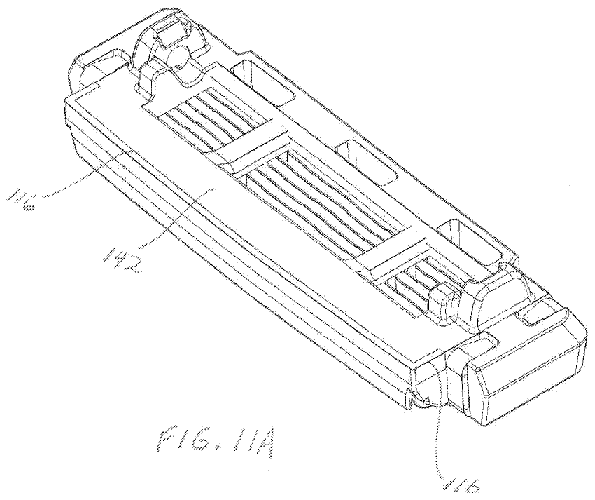

In other implementations, the elastomeric guard 116 may be configured to wrap around the ends and front of the shelf portion 142, as shown in FIGS. 11 and 11A.

Other types of guards may be used, for example honeycomb style guards or guards with other types of skin-engaging features such as spikes or other elastomeric protrusions.

Accordingly, other embodiments are within the scope of the following claims.

What is claimed is:

1. A razor cartridge comprising:
an elongated housing comprising a generally rectangular main portion defining a central open area and having a first width, and a shelf portion extending from the main portion and terminating in a leading edge, the shelf portion having a second width narrower than the first width,
a plurality of blades disposed within the open area of the main portion of the housing, and
a pair of clips disposed on opposite sides of the open area and configured to secure the blades in the housing, each clip having a pair of legs that wrap around the main portion of the housing outboard of the open area and are bent against a lower surface of the main portion.

2. The razor cartridge of claim 1, further comprising an elastomeric guard mounted on the shelf portion such that at least a portion of the elastomeric guard extends beyond the main portion of the housing.

3. The razor cartridge of claim 2 wherein the elastomeric guard comprises a plurality of longitudinally extending fins.

4. The razor cartridge of claim 3 wherein at least some of the fins are disposed outside of the main portion of the housing.

5. The razor cartridge of claim 1 wherein the second width is substantially equal to a width of the open area of the main portion.

6. The razor cartridge of claim 1 wherein the shelf portion extends beyond the main portion a distance of about 2 to 4 mm.

7. The razor cartridge of claim 3 wherein the fins have different lengths, and a longest fin is positioned adjacent the leading edge of the shelf.

8. The razor cartridge of claim 1 wherein both of the legs of each clip are visible along their entire length.

9. The razor cartridge of claim 1 wherein the second width is about 5 to 10 mm less than the first width.

10. A shaving system comprising:
a handle, and
a razor cartridge mounted on a distal end of the handle, the razor cartridge comprising
an elongated housing comprising a generally rectangular main portion defining a central open area and having a first width, and a shelf portion extending from the main portion and terminating in a leading edge, the shelf portion having a second width narrower than the first width,
a plurality of blades disposed within the open area of the main portion of the housing, and
a pair of clips disposed on opposite sides of the open area and configured to secure the blades in the housing, each clip having a pair of legs that wrap around the main portion of the housing outboard of the open area and are bent against a lower surface of the main portion.

11. The shaving system of claim 10, further comprising an elastomeric guard mounted on the shelf portion such that at least a portion of the elastomeric guard extends beyond the main portion of the housing.

12. The shaving system of claim 11 wherein the elastomeric guard comprises a plurality of longitudinally extending fins extending from a common base.

13. The shaving system of claim 12 wherein the elastomeric guard is positioned so that at least some of the fins are disposed outside of the main portion of the housing.

14. The shaving system of claim 11 wherein the second width is substantially equal to a width of the open area of the main portion.

15. The shaving system of claim 11 wherein the shelf portion extends beyond the main portion a distance of about 2 to 4 mm.

16. The shaving system of claim 12 wherein the fins have different lengths, and a longest fin is positioned adjacent the leading edge of the shelf.

17. The shaving system of claim 1 wherein both of the legs of each clip are visible along their entire length.

18. The shaving system of claim 1 wherein the second width is about 5 to 10 mm less than the first width.

19. A method of shaving, the method comprising:
contacting the skin with a razor cartridge, the razor cartridge comprising (a) an elongated housing comprising a generally rectangular main portion defining a central open area and having a first width, and a shelf portion extending from the main portion and terminating in a leading edge, the shelf portion having a second width narrower than the first width, (b) a plurality of blades disposed within the open area of the main portion of the housing, and (c) a pair of clips disposed on opposite sides of the open area and configured to secure the blades in the housing, each clip having a pair of legs that wrap around the main portion of the housing outboard of the open area and are bent against a lower surface of the main portion.
